(19) United States
(12) Patent Application Publication
(10) Pub. No.: US 2011/0307391 A1
(43) Pub. Date: Dec. 15, 2011

(54) AUDITING CROWD-SOURCED COMPETITION SUBMISSIONS

(75) Inventors: Marc E. Mercuri, Bothell, WA (US); Timothy E. Harris, Bellevue, WA (US)

(73) Assignee: MICROSOFT CORPORATION, Redmond, WA (US)

(21) Appl. No.: 12/813,514

(22) Filed: Jun. 11, 2010

(51) Int. Cl. G06Q 10/00

(52) U.S. Cl. 705/300

(57) ABSTRACT

A submission auditing system is described herein that audits to measure participation and to prevent fraud in online crowd-sourced competitions. Auditability increases the acceptance of crowd efforts. Individual contributors and competition organizers also want to have the individual contributors receive credit from the project sponsor(s), their employer, and/or government or other entities for their time investment. An employer may encourage employees to volunteer time with various charitable organizations, and may use the system to monitor participation and award prizes based on participation. The submission auditing system addresses the problem of auditing engagement in crowd-sourced scenarios, by providing a workflow for measuring engagement with a crowdsourcing project, detecting fraud as part of that measurement, and then delivering a receipt for the individual and third parties that provides tracking for participation.

### BACKGROUND

Organizations often have large volumes of work to be performed, sometimes larger than what their employee base can handle. A common solution is to hire temporary workers to temporarily scale up capacity to handle a particular task. Tasks may cover a wide range of activities. For example, a website that receives photos may want to have the photos reviewed for harmful content. An organization that receives essay submissions may want an initial quality check to determine that the submissions adhere to a specified format. These tasks may be centered on events that create brief busy periods, such as a holiday shopping season. It is often inefficient for the organization to grow in size over the long term to meet short-term needs.

Crowdsourcing refers to leveraging crowds of people, usually in an online setting, that have idle time or available time to perform a task. The convergence of the cloud and the crowd provides an organization an opportunity to engage a significant number of people to help solve difficult problems. One approach to this is for an organization to launch a competition. Via the competition, the organization asks people to perform a task and provide submissions related to the task. For example, an organization with a new application-programming interface (API) may enlist developers to create applications based on its APIs and/or data. The developers create applications that performed a task or set of tasks that provide significant value to the organization.

Although crowdsourcing promises to provide enormous capacity and flexibility to organizations on relatively short notice, organizing the participants and evaluating submissions proves to be a daunting task in itself. Today, there is no software infrastructure code available to handle the needs of these types of competitions, and the software is created new by each organization that hosts one. Organizations typically develop a website from scratch, as well as scoring systems, content submission workflows, communication with participants (e.g., email or other notifications), and so forth. Because most organizations do not natively have the expertise for this type of development and few third party developers exist to which to outsource this type of work, organizations often end up not using crowdsourcing as frequently or effectively as is possible. In addition, determining when a submission is valid and whether participants have complete assigned tasks is difficult. Participants and organizers often want to receive some proof of the participation, which limits the replacement of many physical competitions with similar online, crowd-sourced versions.

### SUMMARY

A submission auditing system is described herein that audits to measure participation and to prevent fraud in online crowd-sourced competitions. The system provides a consistent, programmatic/process-driven system that is not subjective like other volunteer efforts (and detects fraud as part of the process). Auditability increases the acceptance of crowd efforts. Individual contributors and competition organizers also want to have the individual contributors receive credit from the project sponsor(s), their employer, and/or government or other entities for their time investment. An employer may even hold competitions between employees or groups to encourage higher levels of participation. An employer may encourage employees to volunteer time with various charitable organizations, and may use the system to monitor participation and award prizes based on participation. The submission auditing system addresses the problem of auditing engagement in crowd-sourced scenarios, by providing a workflow for measuring engagement with a crowdsourcing project, detecting fraud as part of that measurement, and then delivering a receipt for the individual and third parties that provides tracking for participation. Thus, the system unlocks the potential for crowd-sourced competitions to lead to real results that are auditable and fair.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the submission auditing system, in one embodiment.

FIG. 2 is a flow diagram that illustrates processing of the submission auditing system to receive a submission and detect fraud, in one embodiment.

FIG. 3 is a flow diagram that illustrates processing of the submission auditing system to provide a trackable receipt for a submission, in one embodiment.

FIG. 4 is a flow diagram that illustrates processing of the submission auditing system to generate an audit report, in one embodiment.

### DETAILED DESCRIPTION

A submission auditing system is described herein that audits to measure participation and to prevent fraud in online crowd-sourced competitions. At present, there is no mechanism or approach designed to provide auditability for engagement in crowdsourcing. The system provides a consistent, programmatic/process-driven system that is not subjective like other volunteer efforts (and detects fraud as part of the process). Auditability increases acceptance of crowd efforts. Individual contributors and competition organizers also want to have the individual contributors receive credit from the project sponsor(s), their employer, and/or government or other entities for their time investment. For example, an employer may institute a wellness program that asks contributing employees to perform a series of health related tasks. In this example, the employee wants to report the employee's contribution, and the employer may want to monitor and score the contribution to increase participation. The employer may even hold competitions between employees or groups to encourage higher levels of participation. As another example, an employer may encourage employees to volunteer time with various charitable organizations, and may use the system to monitor participation and award prizes based on participation.

The submission auditing system addresses the problem of auditing engagement in crowd-sourced scenarios, by providing a workflow for measuring engagement with a crowdsourcing system/project, detecting fraud as part of that measurement, and then delivering a receipt for the individual and third parties (i.e., government and employers) that provides tracking for participation. Thus, the system unlocks the potential for crowd-sourced competitions to lead to real results that are auditable and fair.

The submission auditing system provides a generic, customizable approach to auditing crowd-sourced competitions, inclusive of identity, administration, monitoring usage, reporting, fraud detection, audit reports/receipts, and so forth. Each of these facilities is described further herein.

A participant has an identity that is used in the system. The identity is either directly issued by a third party (e.g., a government or employer) or contains information that allows it to be federated or associated with third party identities (e.g., goviD, LivelD, OpeniD, Googlel D, and so forth). Submitting an entry provides the identity of the individual/team submitting the entry, the content for the submission, and any additional metadata (e.g., a URL for a cloud-hosted application).

For administration, the submission auditing system provides a web services framework that allows an organization to define activities (e.g., review images, translate text, caption video, and so on). In the process of defining an activity, the organization defines a series of metrics or rules that govern the acceptance of volunteer contributions. Metrics may include a top available score or value for a contribution, tolerance of values outside of the norm of other contributions, acceptable time for completion of a task or set of tasks, average time to completion, and so forth. The organizer uses an administrative interface to design and setup the competition, then allows the system to start hosting the competition.

During the competition, the system provides the organizer with information about usage and other reporting. Crowd sourcing applications employ web services from the submission auditing system to provide input on pieces of the engagement between the crowd sourcing application and a crowd-sourcing participant. This includes time keeping functions that audit the identity and the start/stop time of the contribution, as well as a link to the output of the crowd sourcing volunteering contribution (image feedback, translated text, caption content, and so forth). At the end of an auditing period, the system reviews the contributions of participants and evaluate the context (e.g., time to complete, value) against the defined metrics to assign credit for volunteer work done. The system may provide this information in a report to the competition organizer as well as to each participant.

The submission auditing system also monitors and detects potentially fraudulent submissions. The system places items falling outside of the acceptable norms specified in the metrics definition in a queue, where they can be either reviewed or discarded. If a volunteer has a large set of contributions and a small number of contributions that fall outside of the norm, they may be placed in a priority queue for review. If a volunteer has no prior contributions, they may be placed in a separate, slower queue for review. If a volunteer has a disproportionate number of contributions that fall outside of the norms, they may be placed on another queue. Each participant receives a communication regarding the status of the participant's contributions for the period, optionally including feedback on why content was rejected.

In some embodiments, the submission auditing system provides auditing reports. Some people will participate in a crowd-sourcing project for the intangible benefits of helping an organization, and the audit reports provide a good feeling for them regarding their level engagement. A larger audience will want to have their contributions recognized for payment, tax purposes, and/or third party “matching” of contributions. In these cases, the system provides services that allow third parties to access audit reports for different periods. Participants authorize organizations to view the audits of their contributions and the solution provides both a web service that provides this functionality for third party organizations (e.g., businesses or governments) that would like to integrate this into their internal systems, as well as a web based user interface that is friendlier to small and medium businesses.

The same interfaces are available to participants and can be used for them to either retrieve information directly or consume in widgets/gadgets/software. These interfaces are available to independent software vendors (ISVs) for inclusion in related software (e.g., personal finance or tax software that could utilize the audit information when preparing a tax return).

In addition to the auditing for individuals, the system also offers insight to the organization. As the system records the engagement time of each contribution and for each contributor, the system can provide valuable reporting detail for data points such as engagement time by various time periods, average engagement time per contribution, variances in engagement time based on time of day, and so on.

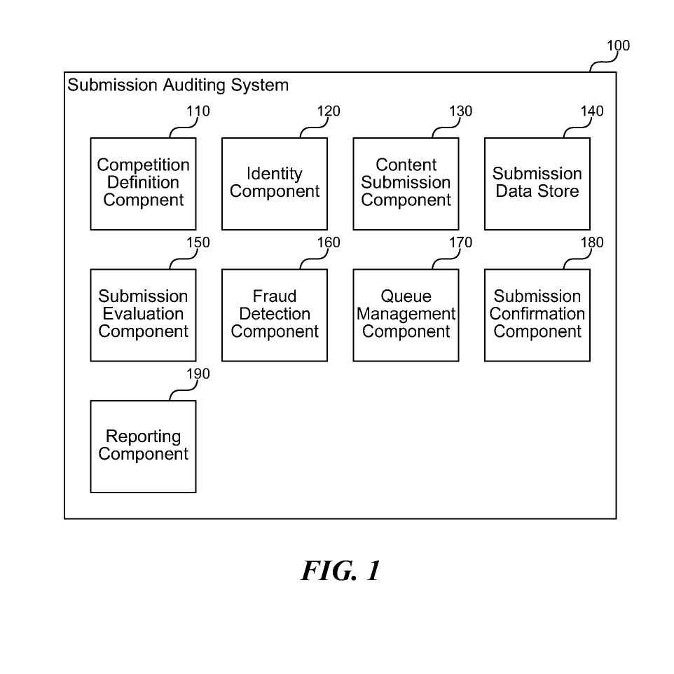

FIG. 1 is a block diagram that illustrates components of the submission auditing system, in one embodiment. The system 100 includes a competition definition component 110, an identity component 120, a content submission component 130, a submission data store 140, a submission evaluation component 150, a fraud detection component 160, a queue management component 170, a submission confirmation component 180, and a reporting component 190. Each of these components is described in further detail herein.

The competition definition component 110 receives information describing a competition from a competition organizer. The information may include limits regarding competition submissions (e.g., number of submissions per participant, rate of submissions per period, size limits of submissions, and so forth) and metrics by which to measure submissions. The information may also include theming information for branding a competition with logos, colors, fonts, or other theming associated with the competition organizer as well as a domain or other web address associated with the competition. The competition definition component 110 may receive information for communications related to the competition, such as email templates that the organizer would like to use for communicating with competition participants. The email templates may include contact information for the organizer, rules of the competition, or other information determined by the organizer. The competition definition component 110 stores competition information in a data store for later retrieval as participants join the competition or send submissions.

The identity component 120 associates a digital identity with each competition participant and verifies the digital identity of participants upon receiving an action from the participant. For example, the system may leverage an existing identity provider (e.g., an Internet Service Provider or email host) or create identities of its own (e.g. associated with an email address, credit card, or other external identity). The system 100 uses the digital identity to audit content submissions and to enforce any limits specified in the competition definition, such as limits on a number of allowed submissions per day per participant. The identity component 120 may include a user interface such as a login page that receives a username and password or other proof of a participant's identity.

The content submission component 130 receives submissions from competition participants related to a goal of the competition. The content submission component 130 may provide a user interface such as a web page for uploading a submission as well as programmatic interfaces, such as a web services API for providing submissions. The content submission component 130 stores received submissions in the submission data store 140. The system may also provide one or more APIs to receive submissions from other software or systems. In some embodiments, the system 100 may rely on another system to handle and provide content submissions and may not include its own content submission component 130. For example, the system may provide a pluggable auditing component that can be used with a variety of other systems that receive and manage content.

The submission data store 140 stores information about competitions and content submissions as the submissions proceed through a workflow processed by the system 100. The submission data store 140 may include one or more files, file systems, databases, cloud-based storage services, or other storage facilities for persisting data across user sessions with the system 100. The submission data store 140 may track a state or status for each submission as well as each identified participant for moving items through the workflow similar to a state machine. Other components update the submission data store 140 as submissions are scored, accepted, rejected, and when submissions place in the competition.

The submission evaluation component 150 evaluates submissions for adherence to one or more competition rules and measures the submissions against one or more task metrics. The rules provided with the competition definition may include limits on the size of submissions, number of submissions per participant in total or over a period, error rate compared to a test data set, and so forth. The submission evaluation component 150 determines whether a submission meets a threshold level of quality and correctness before marking the submission for comprehensive evaluation. If the submission is defective in any way, the submission evaluation component 150 invokes the submission confirmation component 180 to inform the participant that provided the submission so that the participant can make corrections.

The fraud detection component 160 identifies potentially fraudulent submissions and places identified submissions in one or more queues for further review. Fraud detection may include comparing information about the submission to information about the physical world (e.g., faster submissions than is humanly possible), to task metrics defined by the competition organizer (e.g., submissions that lack specified components or fall outside of competition rules), to other submissions (e.g., identifying submissions that have a high deviation from an average of all submissions). These and other indicators can provide evidence of fraudulent or erroneous submissions. Once the system identifies a potentially fraudulent submission, it places the submission in one or more queues. The queues may be automatically or manually reviewed or some combination. The system 100 may prioritize queues based on the degree of deviation of the submission, the history of the user submitting the entry, and so forth. For example, the system 100 may place submissions from users that frequently make acceptable contributions on a fast review queue.

The queue management component 170 manages one or more queues for reviewing user submissions. The queues may be organized by priority or other plans that allow the organizer to effectively manage the competition. Some queues may receive manual review by the organizer or delegates to determine the appropriateness of a submission (such as one that falls sharply outside of average values of one or more parameters), so the prioritization of reviewers' time helps to keep the competition running smoothly. The queues may be stored in the submission data store 140 with submissions.

The submission confirmation component 180 provides a trackable receipt to competition participants after a submission is accepted. The trackable receipt may include both a user communication (e.g., an email) as well as a log retained by the system for later verification of participation to the organizer or other parties (e.g., a government entity, such as for tax purposes). The component 180 may send other messages from the system to participants, from participants to other participants, from the organizer to participants, and so forth. The system 100 may use a variety of communication protocols, such as sending email, short message service (SMS) messages, and so forth. The submission confirmation component 180 keeps participants informed about the status of their submissions, the status of the overall competition, and so on. The system 100 can receive customized communication templates from competition organizers, but also provides default templates for communication if no custom templates are provided. This allows competition organizers to quickly setup a competition but also to invest in as much customization as they choose.

The reporting component 190 gathers and reports statistical information to the competition organizer and to participants. For example, the system may track how many participants have entered the competition, average submissions per participant, time between submissions for each participant, quality of submissions, and so forth. In some embodiments, the system 100 uses the gathered statistics to modify the competition. For example, the system 100 or an organizer may determine that extending the competition for two days will result in 100 more submissions of increasing quality. The reporting component 190 also allows the competition organizer to select a competition winner (and other placing participants, such as second, third, fastest solution, and so on). In some embodiments, the system 100 operator and the competition organizer have contractual payment terms tied to reported statistical information. For example, the competition organizer may pay the system operator a fee per submission, or a weighted fee based on submission quality.

The reporting component 190 also provides an audit trail to both participants and other entities. For example, the competition may be organized by an employer that wants to track employee participation, and the reporting component 190 provides the auditing for that tracking. The participants may also want to provide proof of participation to other entities, and the system provides a trackable receipt as well as reporting that allows the participant to prove the participant's participation.

The computing device on which the submission auditing system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

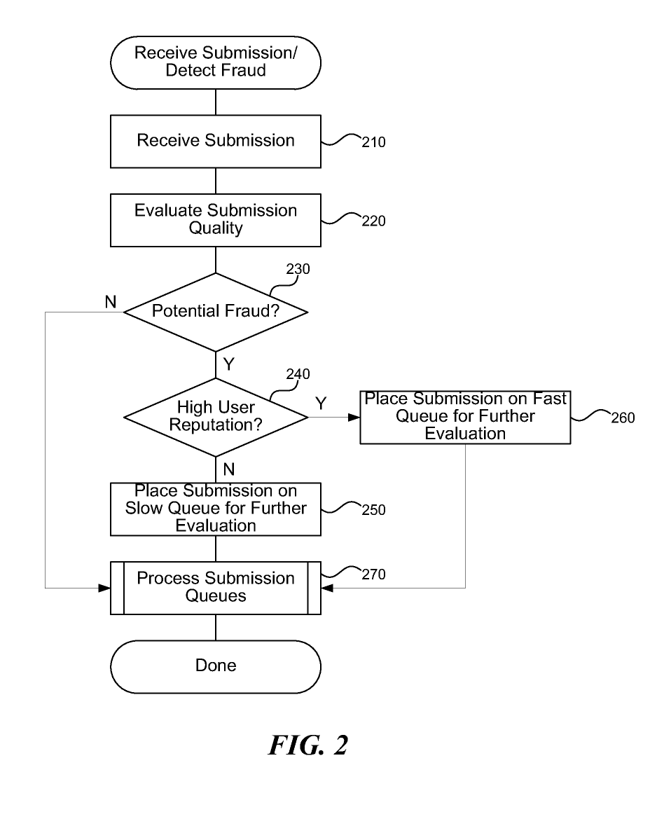

FIG. 2 is a flow diagram that illustrates processing of the submission auditing system to receive a submission and detect fraud, in one embodiment. Beginning in block 210, the system receives a submission related to an online competition from one or more competition participants. The content of the submission may vary based on the type of competition, and may include images, computer software code, data set results, or any other type of data related to the competition. The competition organizer may configure the system to accept particular data types and reject other data types. For example, a particular competition may be configured to accept image files but not executable files.

Continuing in block 220, the system evaluates the received submission to determine whether the submission meets threshold criteria for quality associated with the competition. For example, a competition organizer may specify limits on submission size (e.g., file size, word count, and so forth), file types or content types allowed for submissions, data to be included with a submission, and so on. The system may also compare the submission to threshold metrics that relate to what is possible or likely, so that fraudulent submissions can be detected.

Continuing in decision block 230, if the system detects potential fraud, then the system continues at decision block 240, else the system places the submission on a queue of accepted submissions and continues at block 270. In some embodiments, the system determines a score for the received submission that indicates where the submission ranks compared to other submissions. The system may determine the score based on a variety of factors, such as size of the submission, quality of a test data set output by the submission, resource usage of the submission, and so forth. A score range may be determined by the competition organizer and configured with the system, and the system may assign scores based on rules provided by the competition organizer. For example, an organizer can establish a score range of 0-10, and indicate how points are distributed within the range.

Continuing in decision block 240, if the system determines that the participant from which the submission was received has a high reputation, then the system continues at block 260, else the system continues at block 250. The system may evaluate various criteria of the user, such as quality or quantity of past submissions, past feedback about the participant from other users or competition organizers, and so forth. Continuing in block 250, the system places the submission on a queue of items to be evaluated with a lower priority. Because the system may receive a difficult to manage volume of submissions, the system prioritizes the evaluate of submissions that may be fraudulent, so that those most likely to be okay are quickly detected and those that need more in depth review are evaluated later or potentially discarded without evaluation (e.g., by notifying the participant and encouraging the user to submit a more compliant submission).

If execution continues to block 260, the system places the submission on a queue of items to be evaluated with higher priority. The higher priority queue contains items that are more likely to be false positives for fraud because they come from users that have submitted quality submissions in the past. These submissions can often be evaluated quickly and moved along in the workflow. Although only two queues are shown, those of ordinary skill in the art will recognize that the system can subdivide submissions for later evaluation along a number of criteria and can implement ranked evaluation of submissions in a number of ways with similar results. For example, the system can utilize a single queue with submissions ranked in the queue according to a rank determined by criteria such as the submitter's past history. After block 260, the system jumps to block 270.

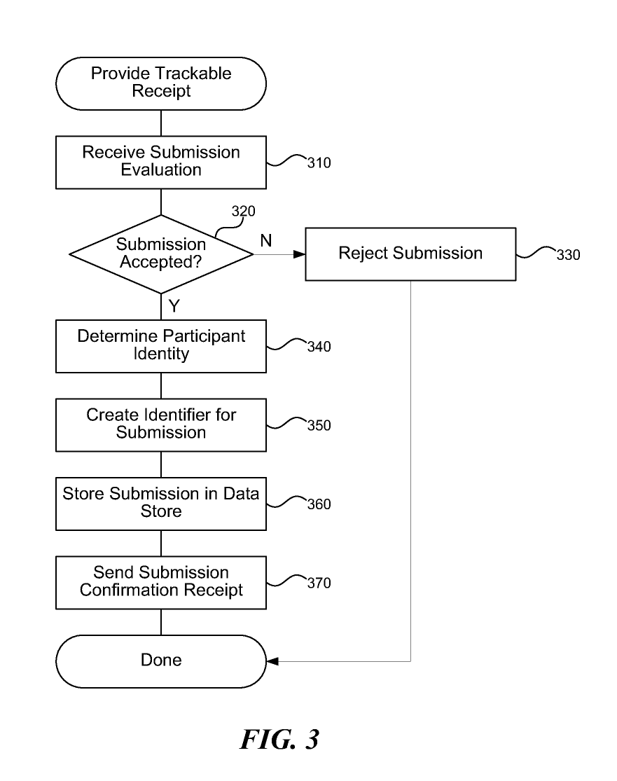

Continuing in block 270, the system processes the submissions on the queues. This process is described further with reference to FIG. 3. The evaluation may include a combination of automatic and manual review that leads to a determination of whether the submission will be accepted as an entry in the competition. After block 270, these steps conclude.

FIG. 3 is a flow diagram that illustrates processing of the submission auditing system to provide a trackable receipt for a submission, in one embodiment. Beginning in block 310, the system receives an evaluation of a received submission. The submission may be one that has already been identified by the system as being potentially fraudulent and thus warranting a higher level of review (see, e.g., FIG. 2). The evaluation process may include automatically determining whether the submission is valid using one or more quality metrics identified by the competition organizer or a system operator. The evaluation process may also include manual review by one or more human reviewers that evaluate the submission and then provide input to the system indicating the validity of the submission.

Continuing in decision block 320, if the received evaluation indicates that the submission be accepted, then the system continues at block 340, else the system continues at block 330. Continuing in block 330, the system rejects the submission and sends a communication to the participant indicating that the submission is rejected. The system may continue to store rejected submissions and allow participants to edit the submissions to make corrections to the submission so that the submission meets acceptable criteria. The system may also allow the participant to make a new submission to replace a rejected submission, so that a rejected submission does not count against any submission limit established by the competition organizer. For clearly fraudulent submissions, the system may discard the submission without notifying the participant. After block 330, the system completes.

Continuing in block 340, the system determines a user identity associated with the participant that provided the submission. For example, the participant may log onto a website or into an application (e.g., on a local computing device such as a computer, mobile phone, or television) associated with a competition to submit a data set or other results of the participant's work related to the competition. The system may provide an identifier to each participant or may rely on a third party identity provider to identify each participant. In some embodiments, the system verifies a certificate, token, or other provided authentication information to determine an identity associated with the participant. Submissions may also be provided by groups or teams, and the system may determine the identity of the team or of each team member individually.

Continuing in block 350, the system creates an identifier with which to associate the submission. The identifier provides a trackable instance number that distinguishes the submission from other submissions and provides an auditable quantity for the submission. In some embodiments, the system uses cryptography to digitally sign or otherwise validate the identifier so that entities relying on the identifier can determine that it was officially produced by the system. Continuing in block 360, the system stores the submission in a data store in association with the created identifier. For example, the system may tag and store each submission in a database and associate a status with the submission that indicates a present state in the workflow for competition submissions.

Continuing in block 370, the system sends a submission confirmation receipt to the participant indicating a disposition of the received submission. For example, the communication may indicate whether the submission was accepted or rejected, what score the submission received, where the participant is currently ranked on the leaderboard, and so forth. The system may also provide a confirmation number or the created identifier to the participant as proof for the submission and for later auditing of the participant's participation. After block 390, these steps conclude.

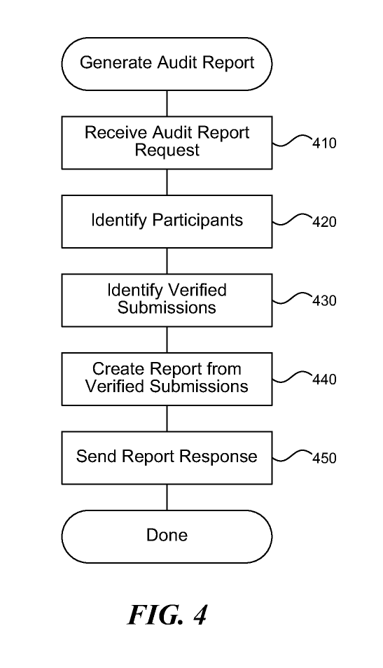

FIG. 4 is a flow diagram that illustrates processing of the submission auditing system to generate an audit report, in one embodiment. Beginning in block 410, the system receives an audit report request that specifies a crowd-sourced competition for which to report auditing information. For example, a competition organizer may request a periodic (e.g., weekly or monthly) report during the course of the competition. As another example, an organizer or third party may request proof of participation by a participant in the competition long after the competition has ended.

Continuing in block 420, the system identifies one or more competition participants related to the report. For example, the request may specify a particular participant or team of participants for which to obtain auditing information. The participant may indicate to a party (e.g., his or her employer) that the participant performed a task in a competition and the party may contact the system to verify that claim through an audit report request. Continuing in block 430, the system identifies one or more verified submissions of the identified one or more competition participants from which to gather data for the requested report. The system tracks auditing information as submissions are received, such as when the submission was received, whether the submission was accepted, how the submission compared to competition criteria (e.g., a score or other evaluation), and so on.

Continuing in block 440, the system creates an audit report that includes information about the identified submissions. The report may include a Boolean indication of whether a particular participant did participate or more sophisticated reporting, such as a number of hours devoted to a task by one or more participants, how well the participants fared in the competition, and so forth. The participants may receive credit from the auditing party based on their submissions and the auditing party uses the system to verify the participants' claims about their participation.

Continuing in block 450, the system sends the created audit report in response to the received audit report request. The request may be received via Hypertext Transport Protocol (HTTP) or other protocols, and the response may include a standard response with the report data for the request protocol. The system may expose auditing information through a variety of interfaces, such as a web site interface, a web services interface, reports downloadable via extensible markup language (XML) file(s), and so forth. After block 450, these steps conclude.

In some embodiments, the submission auditing system receives information from other systems and provides verification of completed tasks. For example, a game console running an exercise game may measure a player's progress through the game. An example is a MICROSOFT™ XBOX™ game that uses MICROSOFT™ Project Natal or other player detection systems to determine that a player is completing jumping jacks or another activity. The submission auditing system receives information about types and quantities of activities performed by the player, and includes this information in an online competition managed by the system. If the player is a participant in a crowd-sourced competition related to fitness, then the player's activities in the game may contribute to an overall measurement of physical activity during a week, for example. The system provides APIs for systems to report this type of information.

In some embodiments, the submission auditing system provides one or more web services that a competition organizer can leverage to build a competition website. The system may provide identity, content submission, scoring, reporting, and other facilities as services of a platform, whereas the competition organizer may provide a user interface that invokes the web services at appropriate times. In other embodiments, the system provides an end-to-end solution including a user interface, and the competition organizer provides data-driven customizations, such as branding and logos.

In some embodiments, the submission auditing system stores content submissions and other data using a cloud-based storage service. For example, MICROSOFT™ Azure, Amazon Web Services, and other platforms provide storage services that a web site or other application can invoke to store data. The system can store participant content submissions using such services, and access the content submissions at various stages of a content evaluation workflow. The system may encrypt or otherwise protect stored content to prevent unwanted access to data.

In some embodiments, the submission auditing system provides participants with an identity that spans competitions. Over time, a participant may build up a reputation for high participation and effective submissions. The participant can include the information on a resume or bio that shows others the participant's skills. Providing this information also incentivizes participants to use the system, as they build up a reputation across competitions and in a manner that endures beyond the lifetime of any single competition. The system may also provide leaderboards and reporting that spans competitions, so that participants can measure performance over time and can compete on an ongoing basis.

In some embodiments, the submission auditing system is provided as a deployable virtual machine instance. Cloud-based services such as MICROSOFT™ Azure and Amazon EC2 often provide deployable instances that represent pre-configured machines or groups of machines ready for specific purposes. For example, services may provide an email server or web server instance. The crowdsourcing competition system can also be provided as a deployable instance, where the competition organizer can modify settings that affect the look and feel, text, and rules of a competition and then have a ready to use web server for hosting the competition.

In some embodiments, the submission auditing system provides a mobile application for monitoring status and participating in competitions. Mobile devices such as MICROSOFT™ WINDOWS™ 7 phones, Apple iPhones and iPads, Google Android phones, and others allow users to install applications that perform a variety of tasks. The competition organizer can provide a branded application for monitoring a particular competition and the system operator can provide an application for monitoring multiple competitions that use the system from mobile devices. The system may also provide integration with online services such as Facebook, Twitter, or others to post a participant's status and to let the participant's friends know that the participant is a member of the competition.

From the foregoing, it will be appreciated that specific embodiments of the submission auditing system have been described herein for purposes of illustration, but that various modifications may be made without deviating from the spirit and scope of the invention. Accordingly, the invention is not limited except as by the appended claims.

I/We claim:

1. A computer-implemented method for providing a trackable receipt for a submission in an online, crowd-sourced competition, the method comprising:
receiving an evaluation of a received submission;
determining whether the received evaluation indicates to accept the submission;
upon determining that the submission is accepted,
determining a user identity associated with a participant that provided the submission;
creating an identifier with which to associate the submission;
storing the submission in a data store in association with the created identifier; and
sending a submission confirmation receipt to the participant indicating acceptance of the received submission,
wherein the preceding steps are performed by at least one processor.

2. The method of claim 1 wherein receiving the evaluation comprises receiving an indication that the submission is potentially fraudulent based on the evaluation.

3. The method of claim 1 wherein receiving the evaluation comprises receiving a result of a human evaluation of the submission.

4. The method of claim 1 wherein receiving the evaluation comprises receiving a result of an automated evaluation of the submission based on one or more quality metrics.

5. The method of claim 1 further comprising, upon determining that the received evaluation does not indicate to accept the submission, rejecting the submission and sending a communication to a participant associated with the submission indicating that the submission is rejected.

6. The method of claim 5 further comprising, following rejection of the submission, allowing the participant to edit the submission to make corrections to the submission so that the submission meets one or more submission criteria.

7. The method of claim 5 further comprising, following rejection of the submission, allowing the participant to make a new submission to replace the rejected submission.

8. The method of claim 1 wherein determining the user identity comprises accessing an identifier associated with the participant provided by an crowd-sourced competition system.

9. The method of claim 1 wherein creating the submission identifier comprises providing a trackable instance number that distinguishes the submission from other submissions and provides an auditable quantity for the submission.

10. The method of claim 1 wherein creating the submission identifier comprises cryptographically signing the identifier so that entities relying on the identifier can determine a source of the identifier.

11. The method of claim 1 wherein sending the submission confirmation receipt comprises providing the created identifier to the participant as proof of the submission.

12. A computer system for hosting and auditing participation in an online competition, the system comprising:
a processor and memory configured to execute software instructions embodied in the following components;
an identity component configured to associate a digital identity with each competition participant and verify the digital identity of participants upon receiving participant submissions.
a submission data store configured to store information about competitions and content submissions as the submissions proceed through a workflow processed by the system;
a submission evaluation component configured to evaluate submissions for adherence to one or more competition rules and measure the submissions against one or more task metrics;
a fraud detection component configured to identify potentially fraudulent submissions and place identified submissions in one or more queues for further review;
a queue management component configured to manage one or more queues for reviewing user submissions;
a submission confirmation component configured to provide a trackable receipt to competition participants after a submission is accepted; and
a reporting component configured to gather and report auditable statistical information.

13. The system of claim 12 wherein the identity component is further configured to retrieve federated identity information from a third party identity provider.

14. The system of claim 12 further comprising a content submission component configured to receive submissions from competition participants related to a goal of the competition, wherein the content submission component is further configured to provide a user interface for uploading a submission.

15. The system of claim 12 wherein the fraud detection component is further configured to compare information about a submission to information about the physical world modeling of possible submission values to determine whether a submission contains one or more impossible or physically difficult results.

16. The system of claim 12 wherein the fraud detection component is further configured to compare information about a submission to task metrics defined by the competition organizer to detect evidence of fraudulent submissions.

17. The system of claim 12 wherein the fraud detection component is further configured to compare information about a submission to other submissions to detect a deviation from one or more average submission metrics.

18. The system of claim 12 wherein the queue management component is further configured to manage at least one queue that is reviewed at a higher priority than other queues based on a determined likelihood that submissions in the queue are likely to be valid.

19. A computer-readable storage medium comprising instructions for controlling a computer system to generate an audit report related to participation in a crowd-sourced competition, wherein the instructions, upon execution, cause a processor to perform actions comprising:
receiving an audit report request that specifies a crowd-sourced competition for which to report auditing information;
identifying one or more competition participants related to the report;
identifying one or more verified submissions of the identified one or more competition participants from which to gather data for the requested report;
creating an audit report that includes information about the identified submissions; and
sending the created audit report in response to the received audit report request.

20. The medium of claim 19 wherein the created report includes an indication of a participant's participation in the competition that is sent as proof to an auditing party in response to the request that the participant participated in the competition.
